(19) United States
(12) Patent Application Publication
(10) Pub. No.: US 2005/0094011 A1
(43) Pub. Date: May 5, 2005

(54) Camera with a delayed shutter release function

(76) Inventors: Elmo Marcus Attila Diederiks, Eindhoven (NL); Bartel Marinus Van De Sluis, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/501,418

(22) PCT Filed: Dec. 23, 2002
(86) PCT No.: PCT/IB02/05701

(30) Foreign Application Priority Data
Jan. 17, 2002 (EP) 02075196.2

(51) Int. Cl. H04N 5/335

(52) U.S. Cl. 348/296

(57) ABSTRACT

A system for controlling the delayed shutter release function comprises a physical separate processing unit (COM) and camera (CAM) which supplies images to the processing unit (COM) to be displayed on a display screen (DS), a hardware or software shutter release button (HSRB; SSRB) is provided, which, when activated by a user, triggers the start of a delay period, a communication link (CL) between the camera (CAM) and the processing unit (COM) allows exchange of control information between the camera (CAM) and the processing unit (COM) to control the delayed shutter release function.

### FIELD OF THE INVENTION

The invention relates to a system for and a method of controlling a delayed shutter release function of a camera. The invention further relates to a camera and a processing unit suitable for use in such a system.

### BACKGROUND OF THE INVENTION

Web cams may have a hardware or software snapshot button. The web cam is coupled to a computer to display its image on a display screen of a display apparatus. Usually, the hardware snapshot button is physically provided on the web cam. When the user activates the hardware snapshot button, the video stream provided by the web cam is instantly frozen and the image at the instant the button is activated is displayed. If a software snapshot button is provided by the suitably programmed computer, the user activates this button with an input device connected to the computer, and again the image is frozen at the instant the button is activated.

The use of the snapshot button in the known web cams often leads to a frozen image with a non-optimal composition.

### SUMMARY OF THE INVENTION

It is an object of the invention to provide a shutter release function in a system comprising a camera and a processing unit leading to an improved composition of the snapshot.

A first aspect of the invention provides a system for controlling a delayed shutter release function as defined in claim 1. A second aspect of the invention provides a method of controlling a delayed shutter release function in a system of a camera and a processing unit as defined in claim 7. A third aspect of the invention provides a camera as defined in claim 8. A fourth aspect of the invention provides a processing unit as defined in claim 9. Advantageous embodiments are defined in the dependent claims.

The system for controlling the delayed shutter release function comprises a processing unit (which preferably is a computer) and a camera which supplies images to the computer. Usually, the images are displayed on a display screen connected to the computer. The computer and the camera are physically separated. A hardware or software shutter release button is provided, which, when activated by a user, triggers the start of a delay period. At the end of the delay period the image is frozen. A communication link is provided between the camera and the computer allowing exchange of control information between the camera and the computer to control the delayed shutter release function.

The time which elapses during the delay period allows the user to find an optimal position with respect to the camera, thereby improving the composition of the image. Preferably, the delay period is generated with a countdown operation.

In the prior art web cams, it is very difficult to obtain the desired composition because the user has to reach for the hardware button on the web cam, or the user has to carefully position the mouse pointer over the software generated button on the display screen to activate this button. These actions heavily distract the user from keeping the correct position with respect to the web cam.

JP-A-100327335 discloses a digital camera with a button for setting a timer mode in which a timer value is set for an automatic shutter. The timer value and its counting down is displayed on a LCD of the camera. In a system in which this prior art camera is connected to a computer, no control information is send via a communication link between the camera and the computer to control the delayed operation of the shutter. The timed shutter is completely controlled by the camera.

In an embodiment of the invention as claimed in claim 2, the camera comprises a hardware shutter release button. When the shutter release button is activated, a start command is generated and supplied to the computer via the communication link. The computer is suitably programmed to perform a countdown operation when the start command is received. The computer supplies an activation command to the camera via the communication link at the end of the count down operation. The camera takes a snapshot in response to the activation command.

In an embodiment of the invention as claimed in claim 3, the shutter release button is generated by software running on the computer. The button is displayed on a display screen. The user has to handle an input device to position a pointer over the software generated button on the display screen to activate this button and the delay operation. At the end of the delay operation, the computer sends a control command to the camera via the communication link to take the snapshot.

In an embodiment of the invention as claimed in claim 4, the camera comprises a hardware shutter release button and a countdown counter. When the shutter release button is activated, a countdown operation starts and the camera generates countdown status information indicating a status of the countdown operation. The countdown status information is transported to the computer via the communication link. The computer is suitably programmed to provide feedback information to the user about the status of the countdown operation. The camera takes a snapshot at the end of its internal countdown operation.

These and other aspects of the invention are apparent from and will be elucidated with reference to the embodiments described hereinafter.

### BRIEF DESCRIPTION OF THE DRAWINGS

In the drawings:

FIG. 1 shows a first embodiment of a system for controlling a delayed shutter release function in accordance with the invention,

FIG. 2 shows a second embodiment of a system for controlling a delayed shutter release function in accordance with the invention,

FIG. 3 shows a third embodiment of a system for controlling a delayed shutter release function in accordance with the invention, and

FIG. 4 shows a fourth embodiment of a system for controlling a delayed shutter release function in accordance with the invention

### DETAILED DESCRIPTION OF THE PREFERRED EMBODIMENT

In the figures, the same references refer to the same elements.

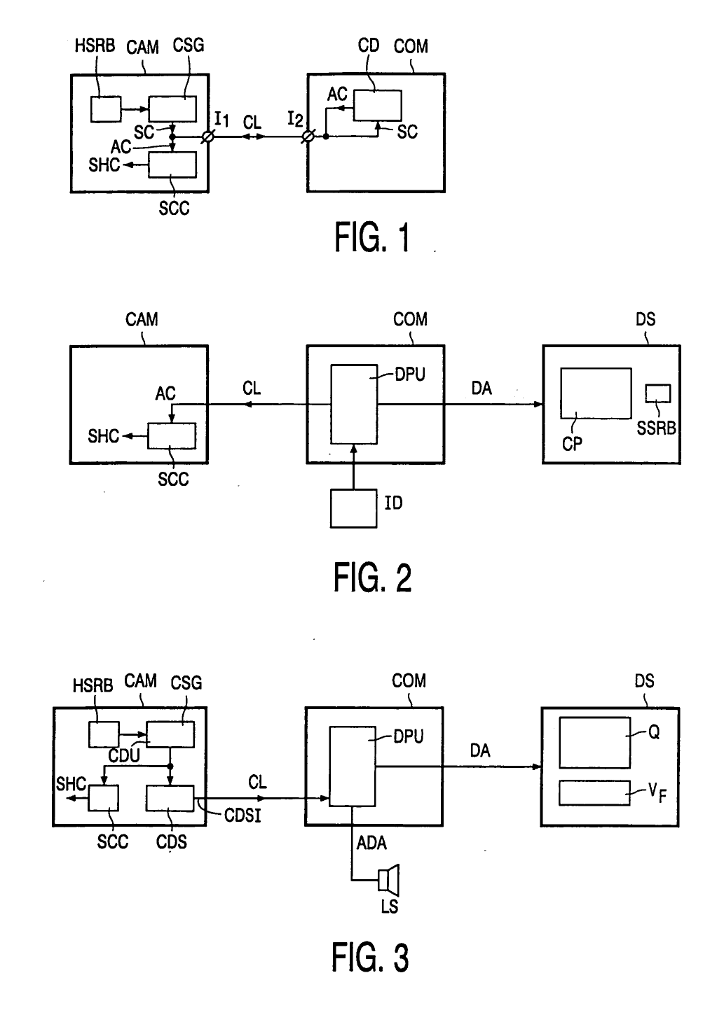

FIG. 1 shows a first embodiment of a system for controlling a delayed shutter release function in accordance with the invention. A camera CAM comprises a hardware shutter release button HSRB, a start command generator CSG, a shutter controller SCC and an interface I1. The processing unit COM comprises a circuit CD for performing a delay operation and an interface I2. The delay operation is preferably a countdown operation. The circuit CD may be a suitably programmed data processing unit (for example a personal computer) or a dedicated hardware circuit. The camera CAM and the processing unit COM communicate via a communication link CL which is arranged between the interfaces I1 and I2.

When the shutter release button HSRB on the camera CAM is activated, the start command generator CSG generates a start command SC which is supplied to the processing unit COM via the communication link CL. The processing unit COM is suitably programmed to perform the countdown operation when the start command SC is received. At the end of the countdown operation, the processing unit COM supplies an activation command AC to the camera CAM via the communication link CL. The camera CAM comprises a shutter controller SCC which generates a snapshot control signal SHC to control the shutter to take a snapshot in response to the received activation command AC.

The start command generator CSG and the shutter controller SCC may be dedicated hardware or a suitably programmed computer.

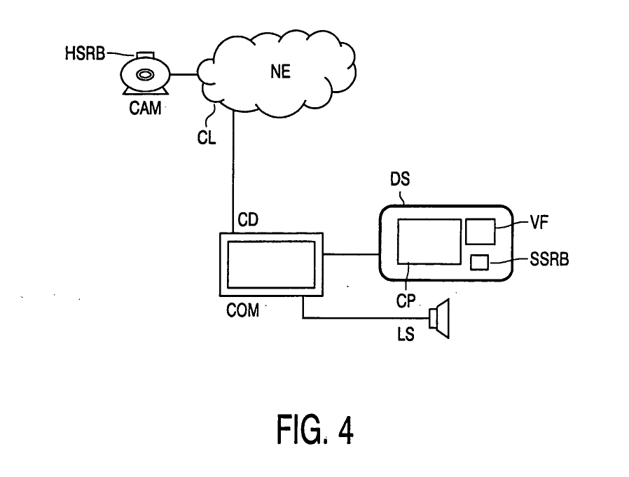

The communication link CL may be a separate hardware link via a suitable communication interface, for example a USB interface. The information to be exchanged via the communication link may also be coded on existing signal, for example the video signal, which must be transported from the camera CAM to the processing unit COM anyhow. The communication link CL may also be a wireless link. In the situation that the camera CAM and the processing unit COM are connected to a network, the communication may also be performed via the network as is elucidated in more detail in FIG. 4.

FIG. 2 shows a second embodiment of a system for controlling a delayed shutter release function in accordance with the invention. A camera CAM comprises the shutter controller SCC. The processing unit COM comprises a data processing unit DPU which is preferably a suitably programmed computer. The camera CAM and the processing unit COM communicate via the communication link CL. The data processing unit DPU supplies display data DA to a display screen DS of a display apparatus.

The data processing unit DPU generates display data DA for showing the video information from the camera CAM on the display screen DS in an area CP, and for displaying a software shutter release button is an area SSRB. When the shutter release button SSRB is selected and activated with a suitable input device ID connected to the processing unit COM, the data processing unit DPU starts a countdown operation. At the end of the countdown operation, the processing unit COM supplies an activation command AC to the camera CAM via the communication link CL. The camera CAM comprises a shutter controller SCC which generates a snapshot control signal SHC to control the shutter to take a snapshot in response to the received activation command AC.

In this second embodiment in accordance with the invention, the shutter release button SSRB is generated by the data processing unit or computer COM and displayed on the display screen DS. The user has to handle an input device DI to position a pointer over the software generated button SSRB on the display screen DS to activate this button SSRB, and consequently the countdown operation. At the end of the countdown operation, the computer COM sends the control command CD to the camera CAM via the communication link CL to take the snapshot. The computer COM may generate a feedback to the user indicating the status of the countdown operation.

FIG. 3 shows a third embodiment of a system for controlling a delayed shutter release function in accordance with the invention.

The camera CAM comprises the hardware shutter release button HRSB, the down counter CDU, the shutter controller SCC, and a countdown status generator CDS.

When the shutter release button HRSB is activated, the countdown counter CDU starts to count down. The countdown status generator CDS in the camera generates countdown status information which is supplied to the computer via the communication link CL. The processing unit COM is suitably programmed to provide feedback information to the user about the status of the countdown operation. The camera CAM takes a snapshot at the end of its internal countdown operation when the countdown counter CDU activates the shutter controller SCC.

The feedback information may be send to the display apparatus where it is displayed on the display screen DS in an area VF. The feedback information may be displayed in any suitable manner, for example, as a down counting number, a flashing symbol, or by changing colors. The display area VF for the feedback information may also be completely or partly within the area CP in which the image of the camera is displayed.

FIG. 4 shows a fourth embodiment of a system for controlling a delayed shutter release function in accordance with the invention. Both the camera CAM and the processing unit or computer COM are connected to a network NE. The distribution of the functions over the camera CAM and the computer COM may be in accordance with any of the previous embodiments shown in FIG. 1 to 3. By way of example, FIG. 4 shows that the computer provides the down counter and the user feedback, and the camera CAM the hardware shutter release button HSRB. The computer COM generates the software shutter release button SSRB and the user feedback on the display screen DS. The operation of the system depends on which shutter release button is activated. If the hardware shutter release button HSRB is activated, the system operates is described with respect to FIG. 1. If the software shutter release button SSRB is activated, the system operates as described with respect to FIG. 2. It is of course not required to provide both a hardware and a software shutter release button. The user feedback may also be produced by a loudspeaker LS suitably driven by the computer COM.

It should be noted that the above-mentioned embodiments illustrate rather than limit the invention, and that those skilled in the art will be able to design many alternative embodiments without departing from the scope of the appended claims.

For example, if suitable the invention can be implemented by means of hardware comprising several distinct elements, and by means of a suitably programmed computer.

Features described with respect to one of the embodiments may be combined with features of another embodiment. For example, the communication link may be wireless in all embodiments, or the feedback to the user about the countdown status may be visual or auditive or both in all embodiments.

In the claims, any reference signs placed between parenthesis shall not be construed as limiting the claim. The word “comprising” does not exclude the presence of other elements or steps than those listed in a claim. In the device claim enumerating several means, several of these means can be embodied by one and the same item of hardware.

1. A system for controlling a delayed shutter release function and comprising:
a camera (CAM) with a shutter and a shutter controller (SCC) for activating the shutter in response to an activation command (AC),
a processing unit (COM) being physically separated from the camera (CAM),
a user activateable shutter release button (HSRB; SSRB),
delay means (CD, DPU; CDU) for generating the activation command (AC) having a time delay with respect to an instant of activation of the shutter release button (HSRB; SSRB), and
a communication link (CL) for exchanging at least one control signal (SC, AC) between the camera (CAM) and the processing unit (COM) to control the delayed shutter release function.

2. A system as claimed in claim 1, wherein the camera (CAM) comprises:
the shutter release button (HSRB),
a camera interface (I1) for supplying a first one of the at least one control signal (SC, AC) being a start command (SC) to the processing unit (COM) via the communication link (CL), and
a control means (CSG) for supplying the start command (SC) to the camera interface (I1) in response to the shutter release button (HSRB; SSRB) being activated,
the processing unit (COM) further comprises an processor interface (I2) for supplying a second one of the at least one control signal (SC) being the activation command (AC) to the camera (CAM) via the communication link (CL),
the processing unit (COM) being programmed for generating the time delay in response to the start command (AC) and for supplying the activation command (AC) to the processor interface (I2).

3. A system as claimed in claim 1, further comprising
a display screen (DS),
the processing unit (COM) being programmed for:
displaying (COM) a shutter release button (SSRB) on the display screen (DS),
generating (COM) the time delay and,
supplying (COM) the at least one control signal (SC, AC) being the activation command (AC) via the communication link (CL) to the camera (CAM),
the camera (CAM) further comprises a camera interface (I1) for receiving the activation command (AC).

4. A system as claimed in claim 1, wherein the camera (CAM) comprises:
the shutter release button (HSRB),
the delay means (CDU) comprising a countdown counter for starting a countdown operation in response to the activation of the shutter release button (HSRB; SSRB), and
status means (CDS) for generating the at least one control signal (SC, AC) being a countdown status information (CDSI) indicating the status of the countdown operation, and
the processing unit (COM) being programmed to generate feedback information (DA; ADA) providing the countdown status information (CDSI) to a user.

5. A system as claimed in claim 1, wherein the processing unit (COM) is further programmed for generating feedback information (DA; ADA) providing a status of the countdown operation to a user.

6. A system as claimed in claim 1, wherein the camera (CAM) is a web cam, and the processing unit (COM) is a computer.

7. A method of controlling a delayed shutter release function in a system comprising:
a camera (CAM) with a shutter,
a processing unit (COM) being physically separated from the camera (CAM),
a shutter release button (HSRB; SSRB), and
a communication link (CL), the method:
generating an activation command (AC) having a time delay with respect to an instant of activation of the shutter release button (HSRB; SSRB),
activating (SCC) the shutter in response to the activation command (AC), and
exchanging at least one control signal (SC, AC) between the camera (CAM) and a processing unit (COM) via the communication link (CL) to control the delayed shutter release function.

8. A camera (CAM) suitable for use in a system as claimed in claim 2.

9. A processing unit (COM) suitable for use in a system as claimed in claim 2.
